(19) United States
(12) Patent Application Publication
(10) Pub. No.: US 2017/0318551 A1
(43) Pub. Date: Nov. 2, 2017

(54) USER EQUIPMENT APPARATUS AND D2D SYNCHRONIZATION SIGNAL TRANSMISSION METHOD

(71) Applicant: NTT DOCOMO, INC., Tokyo (JP)

(72) Inventors: Shimpei Yasukawa, Tokyo (JP); Satoshi Nagata, Tokyo (JP); Yongbo Zeng, Beijing (CN); Qun Zhao, Beijing (CN); Yongsheng Zhang, Beijing (CN)

(73) Assignee: NTT DOCOMO, INC., Tokyo (JP)

(21) Appl. No.: 15/523,186

(22) PCT Filed: Oct. 9, 2015
(86) PCT No.: PCT/JP2015/078777

§ 371 Date: Apr. 28, 2017

(30) Foreign Application Priority Data
Nov. 7, 2014 (JP) 2014-227554

(51) Int. Cl. H04W 56/00; H04W 72/08; H04W 72/04; H04W 88/02; H04W 88/08; H04W 92/18

(52) U.S. Cl. CPC H04W 56/001; H04W 72/082; H04W 72/0446; H04W 88/08; H04W 92/18; H04W 88/02

(57) ABSTRACT

A user equipment apparatus for supporting D2D (user equipment-to-user equipment) communication, the user equipment apparatus being situated in coverage of a base station, including a control unit configured to determine a transmission duration for which a D2D synchronization signal is transmitted according to a parameter related to transmission of the D2D synchronization signal; and a transmission unit configured to transmit the D2D synchronization signal within the determined transmission duration of the D2D synchronization signal.

### TECHNICAL FIELD

The present invention relates to a user equipment apparatus for supporting D2D (user equipment-to-user equipment) communication and a D2D synchronization signal transmission method.

### BACKGROUND ART

In a current mobile communication system such as an LTE (Long Term Evolution) system, communication between user equipment apparatuses UEs is typically performed via a base station eNB or the like by means of communication between the user equipment apparatuses UEs and the base station eNB. Recently, various techniques on D2D communication for direct communication between user equipment apparatuses UEs are under discussion.

In D2D communication in an LTE system, in particular, “Communication” is proposed in order for user equipment apparatuses UEs to perform data communication such as a push call, and “Discovery” is also proposed for a receiving user equipment apparatus UE to detect a transmitting user equipment apparatus UE by using a transmitted discovery signal including an ID of the user equipment apparatus UE, an application ID, or the like (see Non-Patent Document 1). It is expected that Communication will be applied to public safety (police or fire radio and so on), for example.

In order to implement D2D communication, synchronization between user equipment apparatuses UEs needs to be maintained. For synchronization in D2D communication, a D2D synchronization signal (hereinafter also referred to as a “D2DSS”) is defined. A user equipment apparatus (in-coverage user equipment apparatus) UE which is situated in coverage of a base station eNB transmits a D2DSS according to an instruction from the base station eNB when a predetermined condition is satisfied. On the other hand, a user equipment apparatus (out-of-coverage user equipment apparatus) UE which is situated outside coverage of the base station eNB measures a received signal strength of the D2DSS and transmits a D2DSS when the received signal strength of the D2DSS is less than a predetermined threshold.

### PRIOR ART DOCUMENT

### Non-Patent Document

[Non-Patent Document 1] 3GPP TR 36.843 V12.0.1 (2014-03)

### DISCLOSURE OF INVENTION

### Problem(s) to be Solved by the Invention

As mentioned above, an out-of-coverage user equipment apparatus UE transmits a D2DSS according to its own decision, and thus its transmission and reception timing is different from that of an in-coverage user equipment apparatus UE. Even if the out-of-coverage user equipment apparatus UE does not communicate with the in-coverage user equipment apparatus UE, a D2DSS transmitted from the out-of-coverage user equipment apparatus UE may cause interference for the in-coverage user equipment apparatus UE.

FIGS. 1A and 1B show an example where interference occurs in D2D communication. FIG. 1A shows that an in-coverage user equipment apparatus UE1 communicates with a base station eNB and an out-of-coverage user equipment apparatus UE2 transmits a D2D signal. FIG. 1B shows a transmission and reception timing of the base station eNB (i.e., a transmission and reception timing of the in-coverage user equipment apparatus UE1) and a transmission and reception timing of the out-of-coverage UE2.

The in-coverage user equipment apparatus UE1 is in synchronization with the base station eNB and communicates with the base station eNB using a predetermined resource (hereinafter referred to as a “WAN resource”). In addition, the in-coverage user equipment apparatus UE1 performs D2D communication with the out-of-coverage user equipment apparatus UE2 or another in-coverage user equipment apparatus (not shown) using another resource (hereinafter referred to as a “D2D resource”). It is under discussion that the D2D resource uses a portion of uplink resources which are defined as resources for signal transmission from a user equipment apparatus UE to a base station eNB. The WAN resource and the D2D resource are multiplexed in the frequency domain or the time domain.

As shown in FIG. 1B, when the transmission and reception timing of the in-coverage user equipment apparatus UE1 is different from the transmission and reception timing of the out-of-coverage user equipment apparatus UE2, a D2D signal from the out-of-coverage user equipment apparatus UE2 may cause interference with traffic (hereinafter referred to as “D2D traffic”) transmitted from/to the in-coverage user equipment apparatus UE1 using the D2D resource as well as with traffic (hereinafter referred to as “WAN traffic”) transmitted using the WAN resource.

When TDD (time division duplex) is used between the base station eNB and the user equipment apparatus UE1, in particular, a D2D signal from the out-of-coverage user equipment apparatus UE2 causes interference with WAN traffic in uplink (TDD UL) as well as with WAN traffic in downlink (TDD DL). Since the base station eNB cannot directly detect interference with WAN traffic in downlink, the interference cannot be reduced by control from the base station eNB.

Accordingly, in order to reduce interference caused by a D2D signal from the out-of-coverage user equipment apparatus UE2, it is necessary to align the transmission and reception timing of the out-of-coverage user equipment apparatus UE2 with the transmission and reception timing of the base station eNB (i.e., the transmission and reception timing of the in-coverage user equipment apparatus UE1).

In order to align the timing of the user equipment apparatus UE2 with the timing of the user equipment apparatus UE1, the in-coverage user equipment apparatus UE1 can transmit a D2DSS. However, it is not desirable that the in-coverage user equipment apparatus UE1 continuously transmits the D2DSS from the viewpoint of energy consumption. It should be noted that interference with TDD downlink subframes as mentioned above can be avoided by transmitting a D2D broadcast channel (hereinafter referred to as a “PD2DSCH”) together with a D2DSS to provide a TDD UL/DL subframe configuration. However, it is not desirable that the in-coverage user equipment apparatus UE1 continuously transmits the signal from the viewpoint of energy consumption.

It is an object of the present invention to provide an approach to efficiently transmit a D2DSS from the in-coverage user equipment apparatus UE1 in order to reduce interference caused by a D2D signal from the out-of-coverage user equipment apparatus UE2.

### Means for Solving the Problem(s)

In one aspect of the present invention, there is provided a user equipment apparatus for supporting D2D (user equipment-to-user equipment) communication, the user equipment apparatus being situated in coverage of a base station, including:

a control unit configured to determine a transmission duration for which a D2D synchronization signal is transmitted according to a parameter related to transmission of the D2D synchronization signal; and

a transmission unit configured to transmit the D2D synchronization signal within the determined transmission duration of the D2D synchronization signal.

In another aspect of the present invention, there is provided a D2D (user equipment-to-user equipment) synchronization signal transmission method in a user equipment apparatus for supporting D2D communication, the user equipment apparatus being situated in coverage of a base station, including the steps of:

determining a transmission duration for which a D2D synchronization signal is transmitted according to a parameter related to transmission of the D2D synchronization signal; and

transmitting the D2D synchronization signal within the determined transmission duration of the D2D synchronization signal.

### Advantageous Effect of the Invention

According to the present invention, it is possible to efficiently transmit a D2DSS from an in-coverage user equipment apparatus.

### BRIEF DESCRIPTION OF THE DRAWINGS

FIG. 1A shows an example where interference occurs in D2D communication.

FIG. 1B shows an example where interference occurs in D2D communication due to a timing difference between an in-coverage UE and an out-of-coverage UE.

FIG. 2 shows a schematic diagram of a communication system in accordance with an embodiment of the present invention.

FIG. 3 shows a first timing diagram illustrating operations of transmitting and detecting a D2DSS in a communication system in accordance with an embodiment of the present invention.

FIG. 4 shows a second timing diagram illustrating operations of transmitting and detecting a D2DSS in a communication system in accordance with an embodiment of the present invention.

FIG. 5 shows a first sequence diagram illustrating operations of transmitting and detecting a D2DSS in accordance with an embodiment of the present invention.

FIG. 6 shows a second sequence diagram illustrating operations of transmitting and detecting a D2DSS in accordance with an embodiment of the present invention.

FIG. 7 shows a block diagram of a user equipment apparatus in accordance with an embodiment of the present invention.

FIG. 8 shows a block diagram of a baseband signal processing unit in a user equipment apparatus in accordance with an embodiment of the present invention.

FIG. 9 shows a flowchart illustrating operations of a user equipment apparatus (in-coverage user equipment apparatus) in accordance with an embodiment of the present invention.

FIG. 10 shows a flowchart illustrating operations of a user equipment apparatus (out-of-coverage user equipment apparatus) in accordance with an embodiment of the present invention.

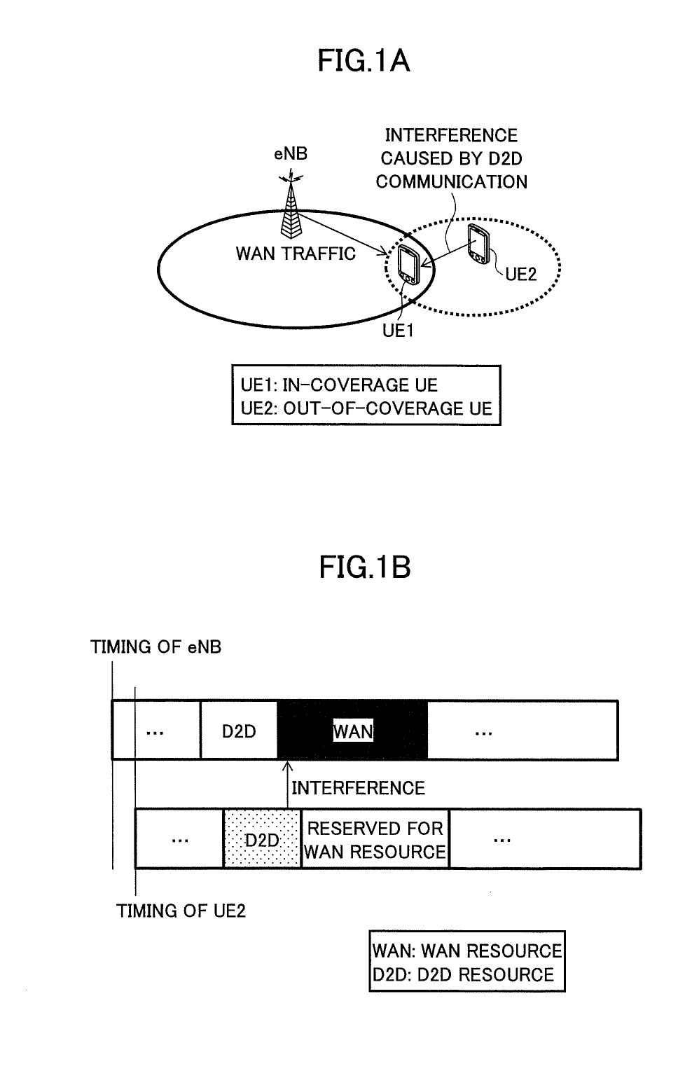

### DETAILED DESCRIPTION OF THE PREFERRED EMBODIMENTS

Embodiments of the present invention are described below with reference to the drawings.

<Overview of Operations in a Communication System>

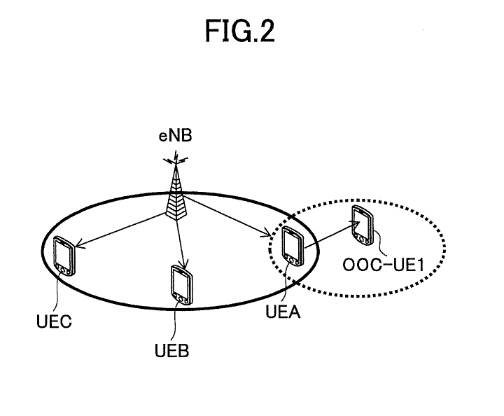

FIG. 2 shows a schematic diagram of a communication system in accordance with an embodiment of the present invention. The communication system in accordance with the embodiment of the present invention is a cellular communication system in which user equipment apparatuses UEA, UEB, and UEC are situated in coverage of a base station eNB. Each of the in-coverage user equipment apparatuses UEA, UEB, and UEC has a D2D communication capability, and D2D communication can be performed between the in-coverage user equipment apparatuses UEA, UEB, and UEC. Each of the in-coverage user equipment apparatuses UEA, UEB, and UEC can also perform D2D communication with an out-of-coverage user equipment apparatus OOC-UE1. In addition, each of the in-coverage user equipment apparatuses UEA, UEB, and UEC can perform cellular communication with the base station eNB as usual. TDD may be used for communication between the user equipment apparatuses UEA, UEB, and UEC, and the base station eNB.

FIG. 2 shows that the user equipment apparatus UEA is situated near the out-of-coverage user equipment apparatus OOC-UE1. In the following description, the user equipment apparatus UEA is taken as an example for explanation. However, the description for the user equipment apparatus UEA can be also applied to the user equipment apparatuses UEB and UEC, because another out-of-coverage user equipment apparatus may be situated near the user equipment apparatuses UEB and UEC.

The out-of-coverage user equipment apparatus OOC-UE1 transmits a D2DSS as a synchronization signal for D2D communication. For example, the out-of-coverage user equipment apparatus OOC-UE1 measures a received signal strength of a D2DSS, and transmits a D2DSS when the received signal strength of the D2DSS is less than a predetermined threshold. The D2DSS transmitted from the out-of-coverage user equipment apparatus OOC-UE1 in this manner may cause interference with WAN traffic of the in-coverage user equipment apparatus UEA.

In order to maintain synchronization with the out-of-coverage user equipment apparatus OOC-UE1, the in-coverage user equipment apparatus UEA transmits a D2DSS to the out-of-coverage user equipment apparatus OOC-UE1. In an embodiment of the present invention, the in-coverage user equipment apparatus UEA intermittently transmits a D2DSS according to a parameter related to transmission of the D2DSS from the viewpoint of reducing energy consumption, rather than continuously transmit a D2DSS with constant periodicity (D2DSS period).

When the out-of-coverage user equipment apparatus OOC-UE1 receives a D2DSS from the in-coverage user equipment apparatus and also transmits a D2DSS, the synchronization timing of the D2DSS to be transmitted may be set according to the last received D2DSS from the in-coverage user equipment apparatus UEA. Since the out-of-coverage user equipment apparatus OOC-UE1 can maintain the synchronization timing for a certain period of time, interference with in-coverage WAN traffic can be reduced for the certain period of time after a D2DSS cannot be received from the in-coverage user equipment apparatus UEA. A period of time to maintain the synchronization timing may be defined in the user equipment apparatus OOC-UE1. After a lapse of the period of time, out-of-synchronization may occur, and thus the user equipment apparatus OOC-UE1 may follow an independent timing or a synchronization timing of another out-of-coverage user equipment apparatus. In addition to maintaining the synchronization timing, the user equipment apparatus OOC-UE1 may also store information provided by a PD2DSCH (for example, a TDD UL/DL subframe configuration).

In addition, in an embodiment of the present invention, the in-coverage user equipment apparatus UEA intermittently detects a D2DSS according to a parameter related to detection of the D2DSS from the viewpoint of reducing energy consumption, rather than continuously detect a D2DSS transmitted from the out-of-coverage user equipment apparatus OOC-UE1.

In the following description, a sequence of a D2DSS is used to distinguish between a D2DSS transmitted from the in-coverage user equipment apparatus UEA and a D2DSS transmitted from the out-of-coverage user equipment apparatus OOC-UE1. The in-coverage user equipment apparatus UEA is in synchronization with the base station eNB and transmits a D2DSS at a predetermined timing in a cell under the base station eNB. A sequence called D2DSSue_net is used for the D2DSS transmitted from the in-coverage user equipment apparatus UEA. On the other hand, the out-of-coverage user equipment apparatus OOC-UE1 may not be in synchronization with the base station eNB and transmit a D2DSS on its own decision. Another sequence called D2DSSue_oon is used for the D2DSS transmitted from the out-of-coverage user equipment apparatus OOC-UE1.

As the parameter related to transmission of the D2DSS and the parameter related to detection of the D2DSS, a detection duration (scanning duration) for which the D2DSS_oon is detected and a D2DSS transmission duration (pure transmission duration) for which D2DSSue_net is transmitted may be defined within a maximum detection duration (Td_max) of the D2DSS. The detection duration is a duration for which the in-coverage user equipment apparatus UEA detects D2DSSue_oon with constant periodicity. The parameter for the detection duration may be determined based on a start time and an end time of detection within Td_max or based on the number of detection durations set within Td_max. The number of detection durations to be actually used may be determined by the user equipment apparatus UEA based on a user equipment capability (for example, a power level) of the user equipment apparatus UEA. For example, the parameter for the detection duration may have information that at least N detection durations should be set within Td_max.

The D2DSS transmission duration is a duration for which the in-coverage user equipment apparatus UEA transmits D2DSSue_net with constant periodicity. The parameter for the D2DSS transmission duration may be determined based on a start time and an end time of transmission within Td_max or based on the minimum number of transmission durations set within Td_max. The number of transmission durations to be actually used may be determined by the user equipment apparatus UEA based on the user equipment capability (for example, a power level) of the user equipment apparatus UEA. For example, the parameter for the D2DSS transmission duration may have information that at least N transmission durations should be set within Td_max. It should be noted that the user equipment apparatus UEA may set the detection duration shorter than the D2DSS transmission duration in consideration of energy consumption for detecting D2DSSue_oon.

When periodicity (D2DSS period) for transmitting a D2DSS is determined in advance, Td_max may be represented by a predetermined number of bits based on a relationship with the D2DSS period. For example, ‘00’ may be used to indicate that Td_max includes two D2DSS periods and ‘01’ may be used to indicate that Td_max includes four D2DSS periods. For example, two of these four D2DSS periods may be defined in advance as the detection durations. Also, ‘10’ may be used to indicate that Td_max includes twelve D2DSS periods. For example, two or four of these twelve D2DSS periods may be defined in advance as the detection durations. Furthermore, ‘11’ may be used to indicate that Td_max includes twenty-four D2DSS periods. For example, two or four of these twenty-four D2DSS periods may be defined in advance as the detection durations.

These parameters (Td_max, the detection duration, and the D2DSS transmission duration) may be broadcast as an SIB (system information block) from the base station eNB, provided by means of signaling from the base station eNB to the individual user equipment apparatus UEA, or set in advance in the user equipment apparatus UEA.

The in-coverage user equipment apparatus UEA may start detection of D2DSSue_oon and transmission of D2DSSue_net autonomously (periodically) or according to an instruction from the base station eNB. Whether detection and transmission are started autonomously or according to an instruction from the base station eNB may be provided by means of signaling from the base station eNB.

For example, the in-coverage user equipment apparatus UEA may stop detection of D2DSSue_oon even during the duration for detecting D2DSSue_oon within Td_max, when D2DSSue_oon from the out-of-coverage user equipment apparatus OOC-UE1 cannot be detected. Similarly, for example, the in-coverage user equipment apparatus UEA may stop transmission of D2DSSue_net even during the duration for transmitting D2DSSue_net within Td_max, when D2DSSue_oon from the out-of-coverage user equipment apparatus OOC-UE1 cannot be detected. Detection and transmission may be stopped autonomously (when the user equipment apparatus UEA does not detect D2DSSue_oon) or according to an instruction from the base station eNB. Whether detection and transmission are stopped autonomously or according to an instruction from the base station eNB may be provided by means of signaling from the base station eNB.

In addition, the in-coverage user equipment apparatus UEA may transmit D2DSSue_net during the detection duration (detection and transmission) or may not transmit D2DSSue_net during the detection duration (detection only). Whether D2DSSue_net is transmitted during the detection duration may be provided by means of signaling from the base station eNB.

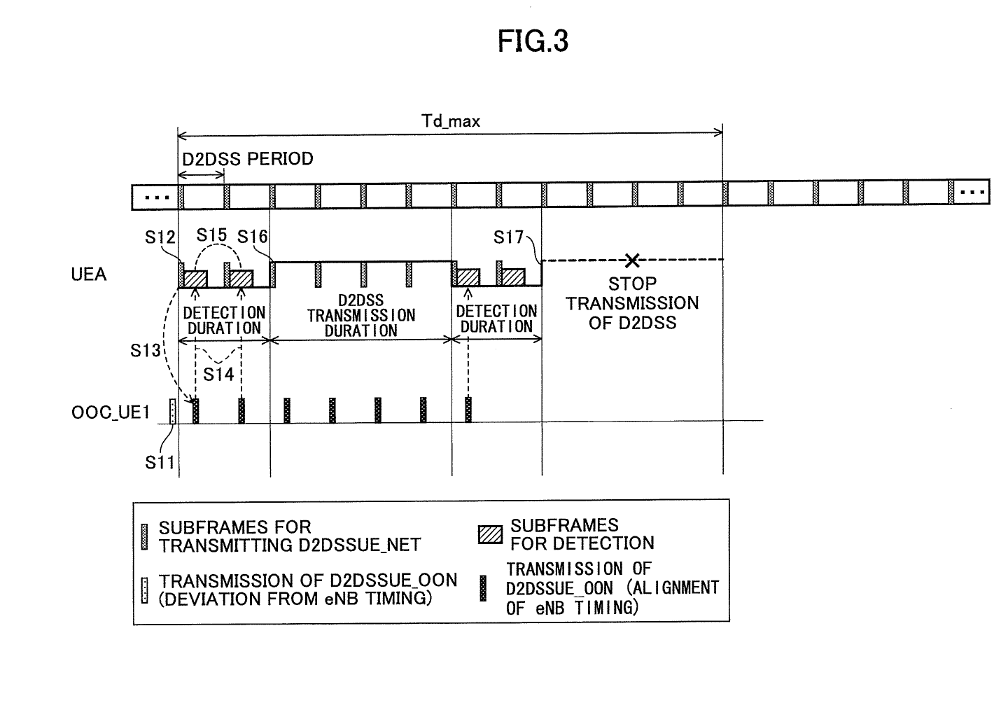

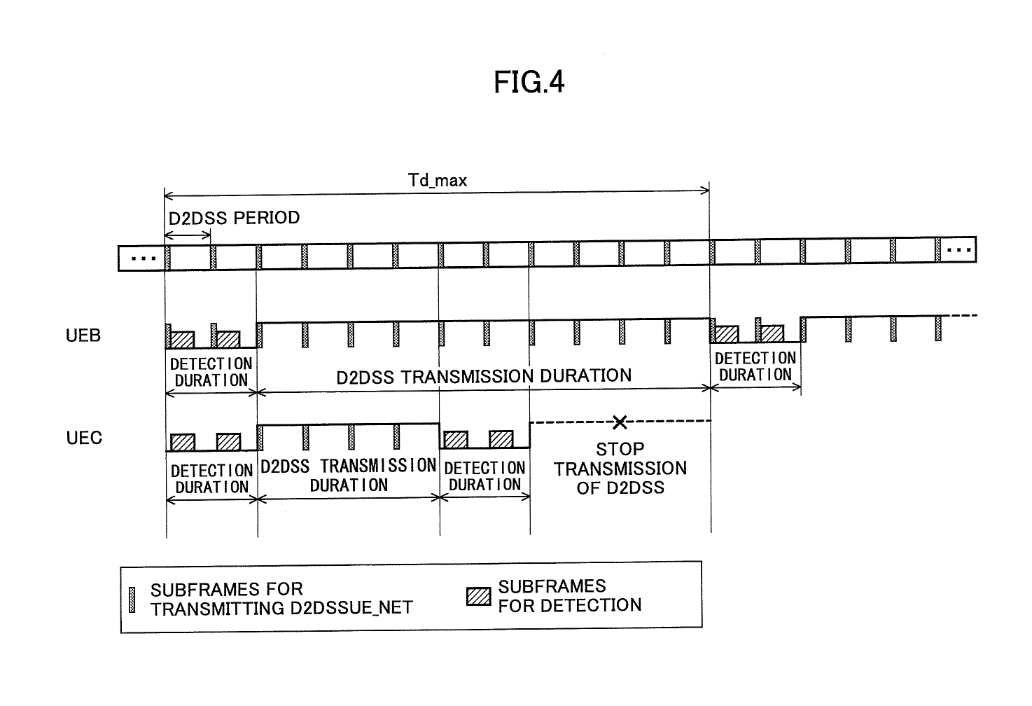

These parameters and operational configurations related to detection of D2DSSue_oon and transmission of D2DSSue_net may vary among user equipment apparatuses. For example, the user equipment apparatus UEA starts transmission and detection according to an instruction from the base station eNB and autonomously stops transmission and detection. The user equipment apparatus UEA also transmits D2DSSue_net during the detection duration (transmission and detection) and the number of detection durations within Td_max is two. For example, the user equipment apparatus UEB starts transmission and detection according to an instruction from the base station eNB and stops transmission and detection according to an instruction from the base station eNB. The user equipment apparatus UEB also transmits D2DSSue_net during the detection duration (transmission and detection) and the number of detection durations within Td_max is one. For example, the user equipment apparatus UEC starts transmission and detection according to an instruction from the base station eNB and autonomously stops transmission and detection. The user equipment apparatus UEC does not transmit D2DSSue_net during the detection duration (detection only) and the number of detection durations within Td_max is two. The operations of the user equipment apparatuses UEA, UEB, and UEC with these operational configurations are described below with reference to FIGS. 3 and 4.

FIGS. 3 and 4 show timing diagrams illustrating transmission and detection operations in a communication system in accordance with an embodiment of the present invention. FIG. 3 shows operations of the in-coverage user equipment apparatus UEA and the out-of-coverage user equipment apparatus OOC-UE1, and FIG. 4 shows operations of the in-coverage user equipment apparatuses UEB and UEC.

As shown in FIG. 3, the out-of-coverage user equipment apparatus OOC-UE1 measures a received signal strength of a D2DSS, and then transmits D2DSSue_oon when the received signal strength of the D2DSS is less than a predetermined threshold (S11).

The in-coverage user equipment apparatus UEA starts transmission of D2DSSue_net and detection of D2DSSue_oon according to an instruction from the base station eNB (S12). Transmission of D2DSSue_net and detection of D2DSSue_oon may be repeated during the detection duration with constant periodicity.

When the out-of-coverage user equipment apparatus OOC-UE1 detects D2DSSue_net (S13), the out-of-coverage user equipment apparatus OOC-UE1 transmits D2DSSue_oon according to the timing of D2DSSue_net, that is, according to the transmission and reception timing of the base station eNB (S14).

The in-coverage user equipment apparatus UEA detects D2DSSue_oon transmitted from the out-of-coverage user equipment apparatus OOC-UE1 during the detection duration (S15). The in-coverage user equipment apparatus UEA may measure interference caused by the detected D2DSSue_oon and transmit an interference measurement result to the base station eNB.

The in-coverage user equipment apparatus UEA also transmits D2DSSue_net during the D2DSS transmission duration (S16). Transmission of D2DSSue_net may be repeated during the D2DSS transmission duration with constant periodicity.

Since the number of detection durations within Td_max for user equipment apparatus UEA is at least two, the in-coverage user equipment apparatus UEA performs transmission of D2DSSue_net and detection of D2DSSue_oon again. Then, when D2DSSue_oon from the out-of-coverage user equipment apparatus OOC-UE1 is not detected, the in-coverage user equipment apparatus UEA autonomously stops detection of D2DSSue_oon and transmission of D2DSSue_net (S17).

As shown in FIG. 4, the in-coverage user equipment apparatus UEB similarly starts transmission of D2DSSue_net and detection of D2DSSue_oon according to an instruction from the base station eNB. The in-coverage user equipment apparatus UEB detects D2DSSue_oon during the single detection duration set within Td_max and transmits D2DSSue_net during the single detection duration set within Td_max. The in-coverage user equipment apparatus UEB repeats detection of D2DSSue_oon and transmission of D2DSSue_net until an instruction from the base station eNB is received.

The in-coverage user equipment apparatus UEC performs detection of D2DSSue_oon and transmission of D2DSSue_net in a similar manner to the user equipment apparatus UEA, except that the in-coverage user equipment apparatus UEC does not transmit D2DSSue_net during the detection duration.

Although the in-coverage user equipment apparatuses UEB and UEC are far from the out-of-coverage user equipment apparatus OOC_UE1, when a D2D signal from the out-of-coverage user equipment apparatus OOC_UE1 can be received, the in-coverage user equipment apparatuses UEB and UEC may report the transmission duration of the D2D signal to the base station eNB. For example, when there is a possibility that the user equipment apparatus OOC_UE1 transmits a D2D signal over a long time, the base station eNB may set Td_max longer to reduce interference from the out-of-coverage user equipment apparatus OOC_UE1.

Next, operations of the in-coverage user equipment apparatus UEA are described below in detail.

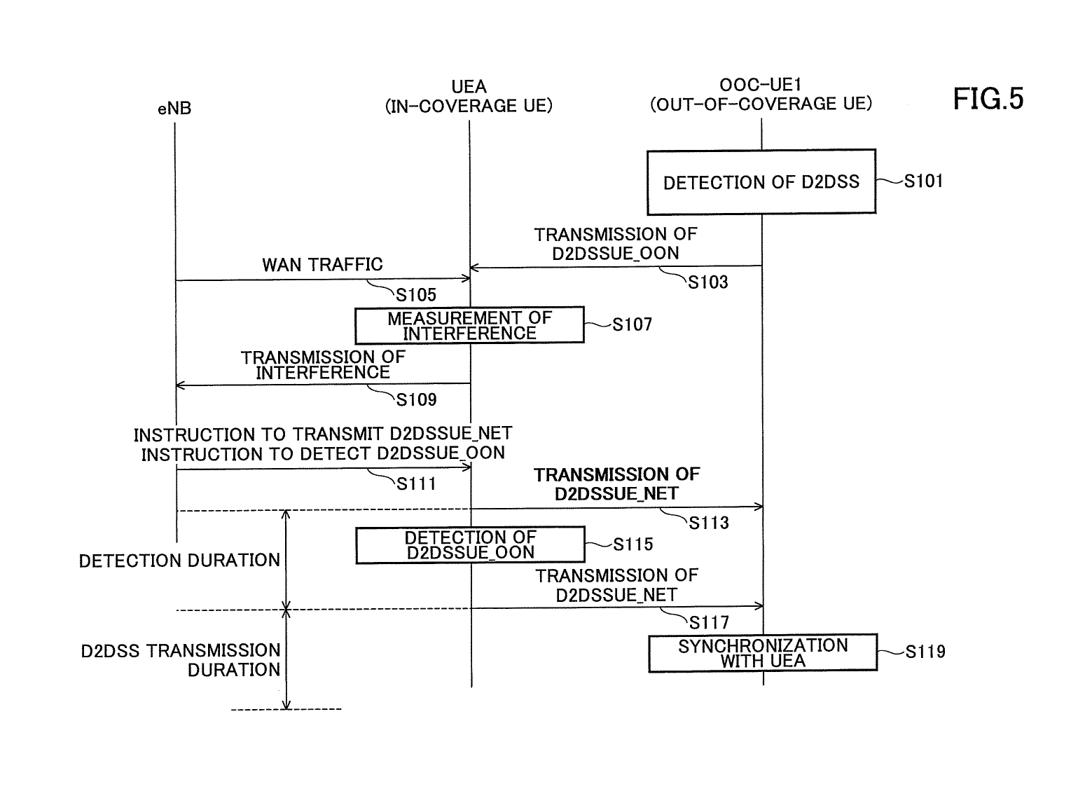

FIG. 5 shows a sequence diagram illustrating operations of transmitting and detecting a D2DSS in accordance with an embodiment of the present invention.

First, the out-of-coverage user equipment apparatus OOC-UE1 detects a D2DSS (S101) and transmits D2DSSue_oon when the received signal strength of the D2DSS is less than a predetermined threshold (S103).

The in-coverage user equipment apparatus UEA detects D2DSSue_oon transmitted from the out-of-coverage user equipment apparatus OOC-UE1. The in-coverage user equipment apparatus UEA also receives downlink data (WAN traffic) when the WAN traffic is transmitted from the base station eNB (S105). The in-coverage user equipment apparatus UEA may measure interference with the WAN traffic caused by D2DSSue_oon (S107) and transmit an interference measurement result to the base station eNB (109).

The base station eNB instructs the in-coverage user equipment apparatus UEA to transmit D2DSSue_net and detect D2DSSue_oon (S111), and the in-coverage user equipment apparatus UEA transmits D2DSSue_net during the detection duration within Td_max according to the instruction from the base station eNB (S113). The in-coverage user equipment apparatus UEA also detects D2DSSue_oon during the detection duration within Td_max (S115). When D2DSSue_oon is detected, the in-coverage user equipment apparatus UEA may measure interference with the WAN traffic caused by D2DSSue_oon and transmits an interference measurement result to the base station eNB (not shown).

Then, the in-coverage user equipment apparatus UEA transmits D2DSSue_net during the D2DSS transmission duration within Td_max (S117). When the out-of-coverage user equipment apparatus OOC-UE1 detects D2DSSue_net, the out-of-coverage user equipment apparatus OOC-UE1 synchronizes with the in-coverage user equipment apparatus UEA (S119). While FIG. 5 shows that the out-of-coverage user equipment apparatus OOC-UE1 synchronizes with the in-coverage user equipment apparatus UEA after step S117, when the out-of-coverage user equipment apparatus OOC-UE1 can detect D2DSSue_net transmitted in step S113, the out-of-coverage user equipment apparatus OOC-UE1 can synchronize with the in-coverage user equipment apparatus UEA during the detection duration before the D2DSS transmission duration.

When the received signal strength of D2DSSue_net received by the out-of-coverage user equipment apparatus OOC-UE1 is equal to or more than the predetermined threshold, the out-of-coverage user equipment apparatus OOC-UE1 stops transmission of D2DSSue_oon. Consequently, when the in-coverage user equipment apparatus UEA does not detect D2DSSue_oon from the out-of-coverage user equipment apparatus OOC-UE1, the in-coverage user equipment apparatus UEA may stop detection of D2DSSue_oon and transmission of D2DSSue_net even within Td_max.

Next, operations of the in-coverage user equipment apparatus UEC are described below in detail.

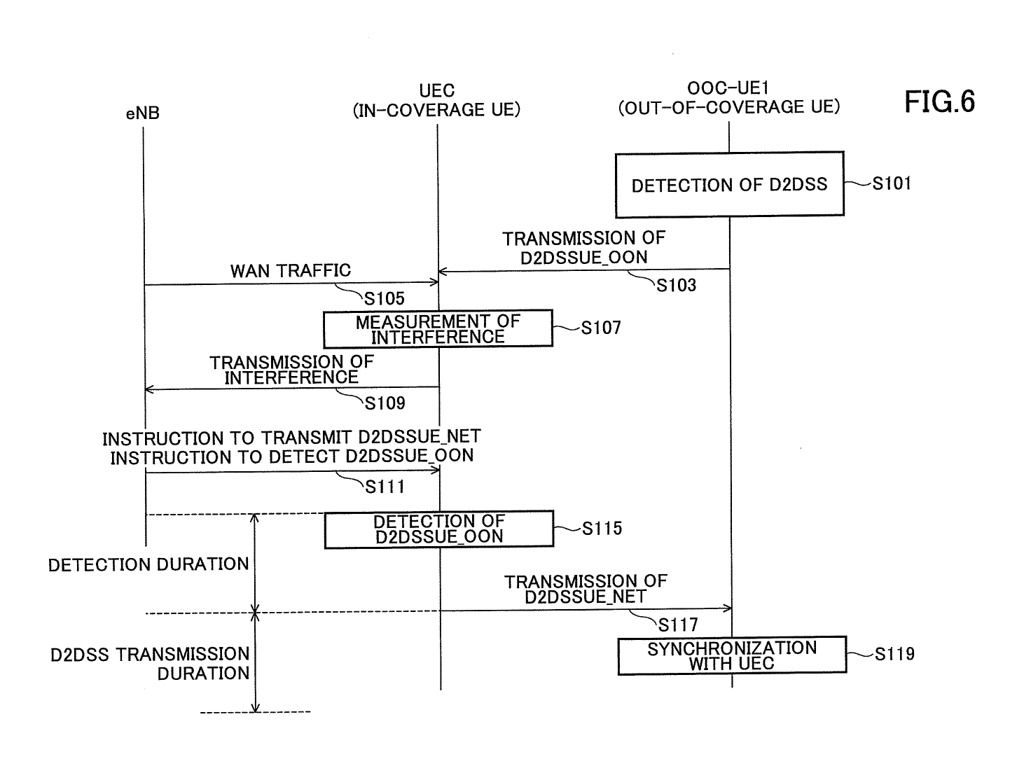

FIG. 6 shows a sequence diagram illustrating operations of transmitting and detecting a D2DSS in accordance with an embodiment of the present invention. FIG. 6 is the same as FIG. 5 except that step S113 in FIG. 5 is not performed in FIG. 6.

Steps S101-S109 are performed as described with reference to FIG. 5.

The base station eNB instructs the in-coverage user equipment apparatus UEC to transmit D2DSSue_net and detect D2DSSue_oon (S111), and the in-coverage user equipment apparatus UEC detects D2DSSue_oon during the detection duration within Td_max according to the instruction from the base station eNB (S115). During this detection duration, the in-coverage user equipment apparatus UEC dos not transmit D2DSSue_net. When D2DSSue_oon is detected, the in-coverage user equipment apparatus UEC may measure interference with the WAN traffic caused by D2DSSue_oon and transmit an interference measurement result to the base station eNB (not shown).

Then, the in-coverage user equipment apparatus UEC transmits D2DSSue_net during the D2DSS transmission duration within Td_max (S117). When the out-of-coverage user equipment apparatus OOC-UE1 detects D2DSSue_net, the out-of-coverage user equipment apparatus OOC-UE1 synchronizes with the in-coverage user equipment apparatus UEC (S119). Since D2DSSue_net is not transmitted during the detection duration according to the procedure shown in FIG. 6, the timing when the out-of-coverage user equipment apparatus OOC-UE1 synchronizes with the user equipment apparatus UEC may suffer a longer delay compared to the procedure shown in FIG. 5.

<Configuration of an in-Coverage User Equipment Apparatus>

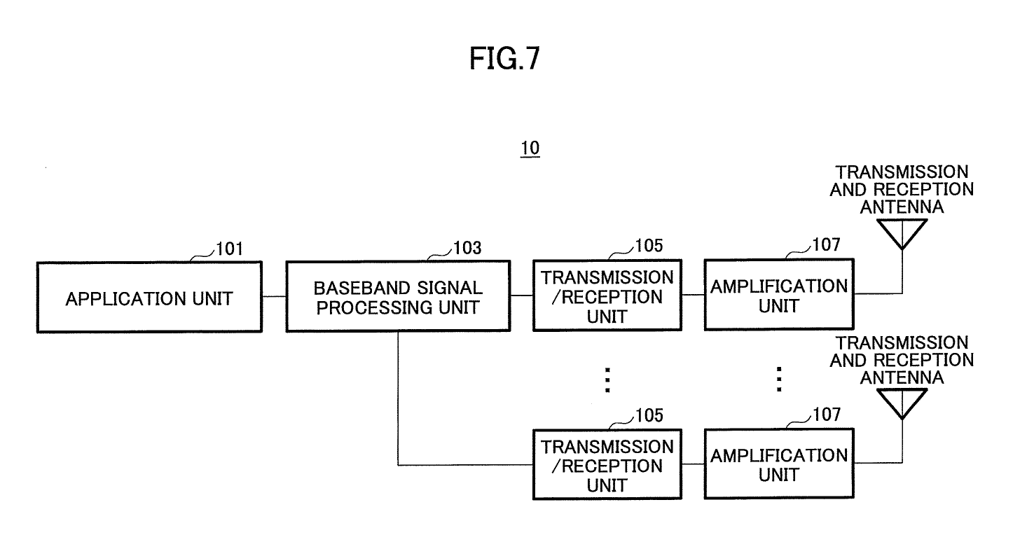

FIG. 7 shows a block diagram of a user equipment apparatus 10 in accordance with an embodiment of the present invention. The user equipment apparatus 10 is a user equipment apparatus situated in coverage of a base station eNB and has a D2D communication capability. The user equipment apparatus 10 includes an application unit 101, a baseband signal processing unit 103, a transmission/reception unit 105, and an amplification unit 107. The user equipment apparatus 10 may be an information and communication terminal including a processor such as a CPU (central processing unit), a memory device such as a RAM (random access memory) and a ROM (read only memory), a storage device such as a hard disk, and so on. For example, the application unit 101, the baseband signal processing unit 103, or the like may be implemented in the processor and the storage device or the memory device and realized by processing data or executing a program stored in the storage device or the memory device in the processor.

Regarding downlink data, a radio frequency signal received by a transmission and reception antenna is amplified by the amplification unit 107, and frequency-converted to a baseband signal by the transmission/reception unit 105. The baseband signal processing unit 103 performs reception processing of the baseband signal such as FFT processing, error correction decoding, and retransmission control. Downlink user data in the downlink data are forwarded to the application unit 101. The application unit 101 performs processing on a higher layer than the physical layer or the MAC layer, for example.

On the other hand, uplink data are input from the application unit 101 to the baseband signal processing unit 103. The baseband signal processing unit 103 performs transmission processing for retransmission control, channel encoding, DFT processing, and IFFT processing. The transmission/reception unit 105 converts a baseband signal output from the baseband signal processing unit 103 to a radio frequency band signal. Then, the signal is amplified by the amplification unit 107 and transmitted from the transmission and reception antenna.

In an embodiment of the present invention, the base band signal processing unit 103 determines the transmission duration for transmitting D2DSSue_net, determines the detection duration for detecting D2DSSue_oon, generates D2DSSue_net, detects D2DSSue_oon, measures interference caused by D2DSSue_oon, and so on. In the following description, a configuration of the baseband signal processing unit 103 is described in detail.

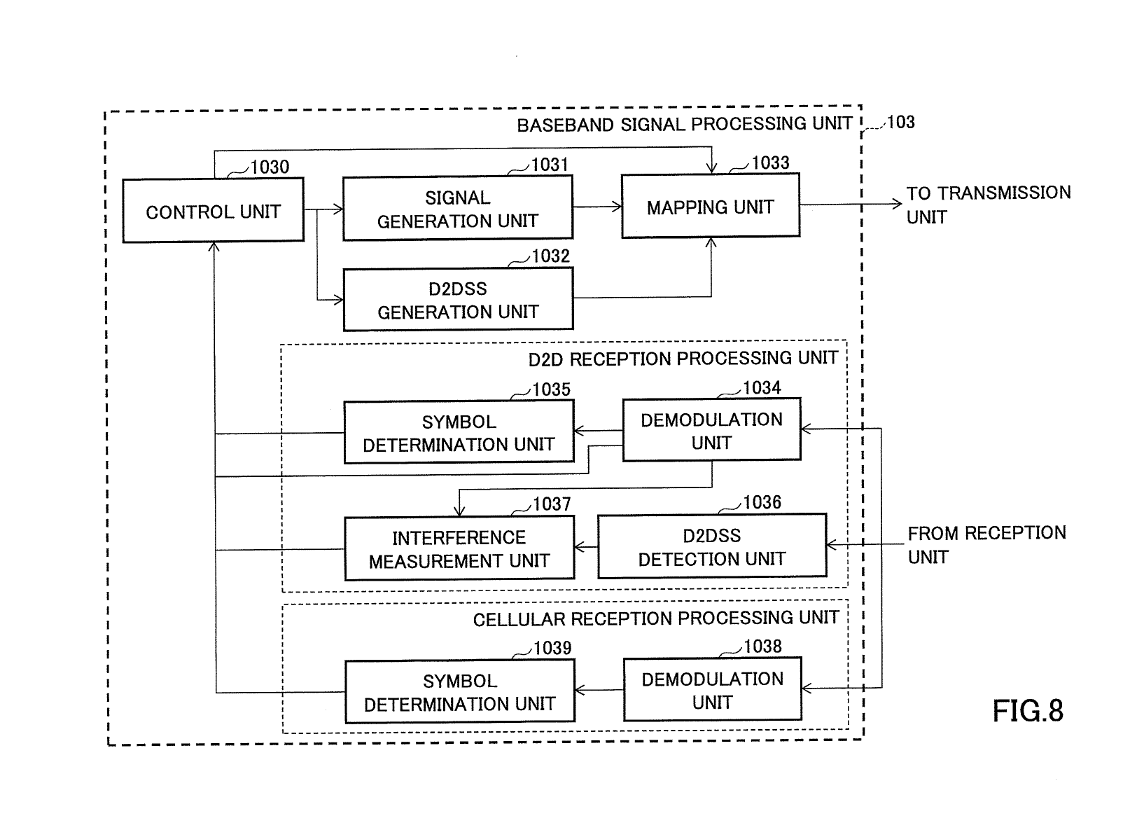

FIG. 8 shows a block diagram of the baseband signal processing unit 103 in the user equipment apparatus 10 in accordance with an embodiment of the present invention. The baseband signal processing unit 103 includes a control unit 1030, a signal generation unit 1031, a D2DSS generation unit 1032, a mapping unit 1033, a demodulation unit 1034, a symbol determination unit 1035, a D2DSS detection unit 1036, and an interference measurement unit 1037 for D2D reception processing, and a demodulation unit 1038 and a symbol determination unit 1039 for cellular reception processing. While the baseband signal processing unit 103 shown in FIG. 8 separately includes the functional units for D2D reception processing and the functional units for cellular reception processing, at least part of these functional units may be shared for D2D reception processing and cellular reception processing.

The control unit 1030 performs total management of the baseband signal processing unit 103. To transmit a signal to a base station eNB through uplink, the control unit 1030 provides data input from the application unit 101 to the signal generation unit 1031. The control unit 1030 also determines a transmission duration for transmitting D2DSSue_net and a detection duration for detecting D2DSSue_oon according to parameters for Td_max, the detection duration, the D2DSS transmission duration, and so on. These parameters may be transmitted by means of an SIB from the base station eNB or by means of signaling to the individual user equipment apparatus and stored in a memory or the like in the user equipment apparatus 10. Alternatively, these parameters may be stored in advance in the memory or the like in the user equipment apparatus 10. The control unit 1030 also starts or stops transmission of D2DSSue_net and detection of D2DSSue_oon. The control unit 1030 may further determine whether to transmit D2DSSue_net during the detection duration according to signaling from the base station eNB.

The signal generation unit 1031 generates a signal to be transmitted to the base station eNB or another user equipment apparatus. A signal to be transmitted to the base station eNB includes data and control information and is transmitted using a WAN resource. A signal to be transmitted to the other user equipment apparatus includes an SA (scheduling assignment), a discovery signal, D2D data, and so on and is transmitted using a D2D resource.

The D2DSS generation unit 1032 generates D2DSSue_net to be transmitted to another user equipment apparatus. The D2DSSue_net is transmitted using a D2D resource during the D2DSS transmission duration determined by the control unit 1030.

The mapping unit 1033 places the signals generated by the signal generation unit 1031 and the D2DSS generation unit 1032 on a WAN resource and a D2D resource. The signals placed on the resources by the mapping unit 1033 are transmitted to the base station eNB or the other user equipment apparatus via the transmission/reception unit 105, the amplification unit 107, and the transmission and reception antenna.

The demodulation unit 1034 demodulates a D2D signal transmitted using a D2D resource from another user equipment apparatus.

The symbol determination unit 1035 obtains a symbol bit sequence of the demodulated D2D signal and inputs the symbol bit sequence to the control unit 1030.

The D2DSS detection unit 1036 detects a D2DSS. Specifically, the D2DSS detection unit 106 detects D2DSSue_oon during the detection duration determined by the control unit 1030.

The interference measurement unit 1037 measures interference caused by D2DSSue_oon, when D2DSSue_oon is detected by the D2DSS detection unit 1036. An interference measurement result by the interference measurement unit 1037 is input to the control unit 1030 and then is generated by the signal generation unit 1031 as a signal to be transmitted to the base station eNB.

The demodulation unit 1038 demodulates a cellular signal transmitted from the base station eNB using a WAN resource.

The symbol determination unit 1039 obtains a symbol bit sequence of the demodulated cellular signal and inputs the symbol bit sequence to the control unit 1030. The cellular signal input from the symbol determination unit 1039 to the control unit 1030 includes signaling from the base station eNB. For example, when the base station eNB provides parameters for Td_max, the detection duration, the D2DSS transmission duration, and so on, when the base station eNB instructs the user equipment apparatus to start or stop transmission of D2DSSue_net and detection of D2DSSue_oon, or when the base station eNB provides signaling as to whether to transmit D2DSSue_net during the detection duration, the cellular signal input from the symbol determination unit 1039 to the control unit 1030 includes these parameters or the signaling.

<Operations of an in-Coverage User Equipment Apparatus>

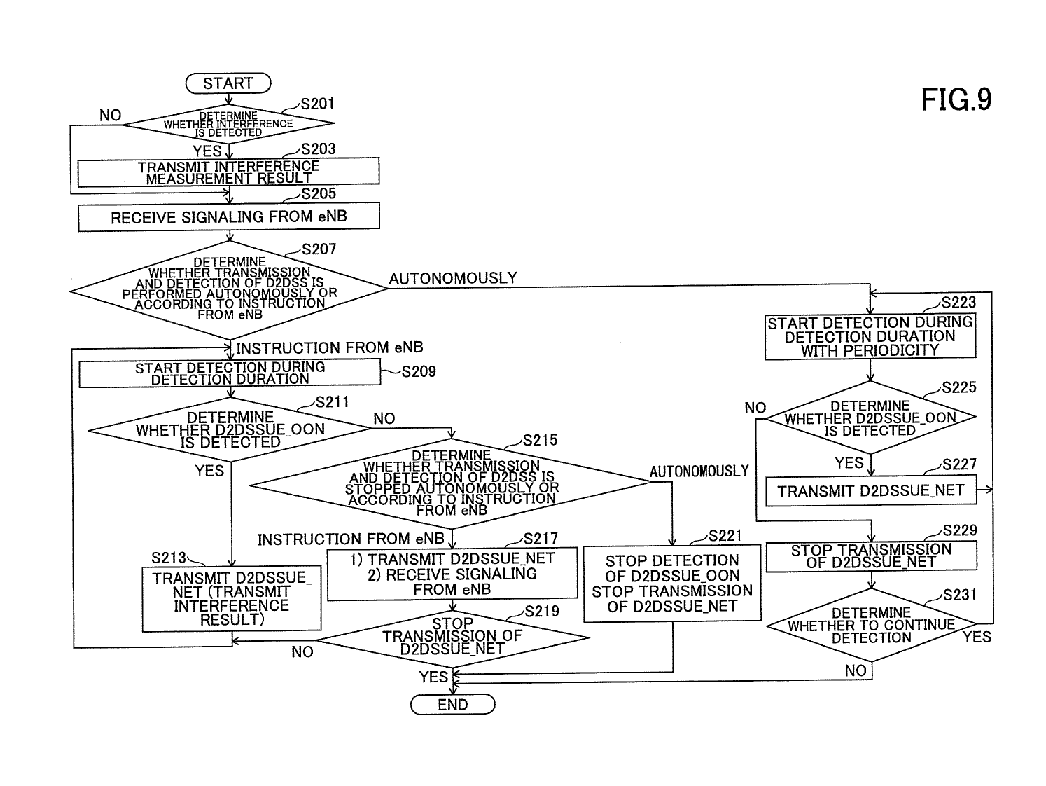

FIG. 9 shows a flowchart illustrating operations of the user equipment apparatus 10 in accordance with an embodiment of the present invention.

The user equipment apparatus 10 receives D2DSSue_oon transmitted from an out-of-coverage user equipment apparatus in the demodulation unit 1034 and the symbol determination unit 1035. The user equipment apparatus 10 also receives a cellular signal transmitted from the base station eNB in the demodulation unit 1038 and the symbol determination unit 1039. The user equipment apparatus 10 measures interference with the cellular signal caused by D2DSSue_oon in the interference measurement unit 1037 and inputs the measurement result to the control unit 1030 (S201). When interference is detected (S201:YES), the signal generation unit 1031 generates a signal including the measurement result to transmit an interference result to the base station eNB (S103). It should be noted that steps S201 and S203 may not be performed by the user equipment apparatus 10.

Then, the user equipment apparatus 10 may receive parameters for Td_max, the detection duration, the D2DSS transmission duration, and so on in the demodulation unit 1038 and the symbol determination unit 1039 (S205). The user equipment apparatus 10 may also receive an indication as to whether to start or stop detection of D2DSSue_oon and transmission of D2DSSue_net autonomously or according to an instruction from the base station eNB in the demodulation unit 1038 and the symbol determination unit 1039.

When detection of D2DSSue_oon and transmission of D2DSSue_net are started according to an instruction from the base station eNB (S207), the control unit 1030 in the user equipment apparatus 10 starts, according to the instruction from the base station eNB, detection by the D2DSS detection unit 1036 of D2DSSue_oon during the detection duration (S209). When D2DSSue_oon is detected by the D2DSS detection unit 1036 (S211:YES), the user equipment apparatus 10 generates D2DSSue_net in the D2DSS generation unit 1032 and places D2DSSue_net on a D2D resource in the mapping unit 1033 to transmit D2DSSue_net (S213). The user equipment apparatus 10 may also measure interference with the cellular signal caused by D2DSSue_oon in the interference measurement unit 1037 and transmit the measurement result to the base station eNB. Then, the procedure returns to step S209, where detection of D2DSSue_oon is continued.

On the other hand, when D2DSSue_oon is not detected by the D2DSS detection unit 1036 (S211:NO), the control unit 1030 in the user equipment apparatus 10 determines whether to stop detection of D2DSSue_oon and transmission of D2DSSue_net autonomously or according to an instruction from the base station eNB. When detection of D2DSSue_oon and transmission of D2DSSue_net are stopped according to an instruction from the base station eNB (S215), the user equipment apparatus 10 generates D2DSSue_net in the D2DSS generation unit 1032 and places D2DSSue_net on a D2D resource in the mapping unit 1033 to transmit D2DSSue_net until an instruction from the base station eNB is received (S217). When the user equipment apparatus 10 receives an instruction from the base station eNB, the control unit 103 stops detection of D2DSSue_oon and transmission of D2DSSue_net (S219:YES). When no instruction to stop detection of D2DSSue_oon and transmission of D2DSSue_net is received and detection of D2DSSue_oon is continued during the detection duration (S219:NO), the procedure returns to step S209.

On the other hand, when detection of D2DSSue_oon and transmission of D2DSSue_net are stopped autonomously (S215) and D2DSSue_oon is not detected by the D2DSS detection unit 1036, the control unit 1030 stops detection of D2DSSue_oon and transmission of D2DSSue_net (S221).

When detection of D2DSSue_oon and transmission of D2DSSue_net are started autonomously (S207), the user equipment apparatus 10 periodically starts detection of D2DSSue_oon in the D2DSS detection unit 1036 (S223). In this case, it is assumed that detection of D2DSSue_oon and transmission of D2DSSue_net are also stopped autonomously. When D2DSSue_oon is detected by the D2DSS detection unit 1036 (S225:YES), the user equipment apparatus 10 generates D2DSSue_net in the D2DSS generation unit 1032 and places D2DSSue_net on a D2D resource in the mapping unit 1033 to transmit D2DSSue_net (S227). In this case, the user equipment apparatus 10 may also measure interference with the cellular signal caused by D2DSSue_oon in the interference measurement unit 1037 and transmit the measurement result to the base station eNB.

On the other hand, when D2DSSue_oon is not detected by the D2DSS detection unit 1036 (S225), the control unit 1030 stops detection of D2DSSue_oon and transmission of D2DSSue_net (S229). When detection of D2DSSue_oon and transmission of D2DSSue_net are not stopped and thus detection of D2DSSue_oon is continued during the detection duration (S231:YES), the procedure returns to step S223.

<Operations of an Out-of-Coverage User Equipment Apparatus>

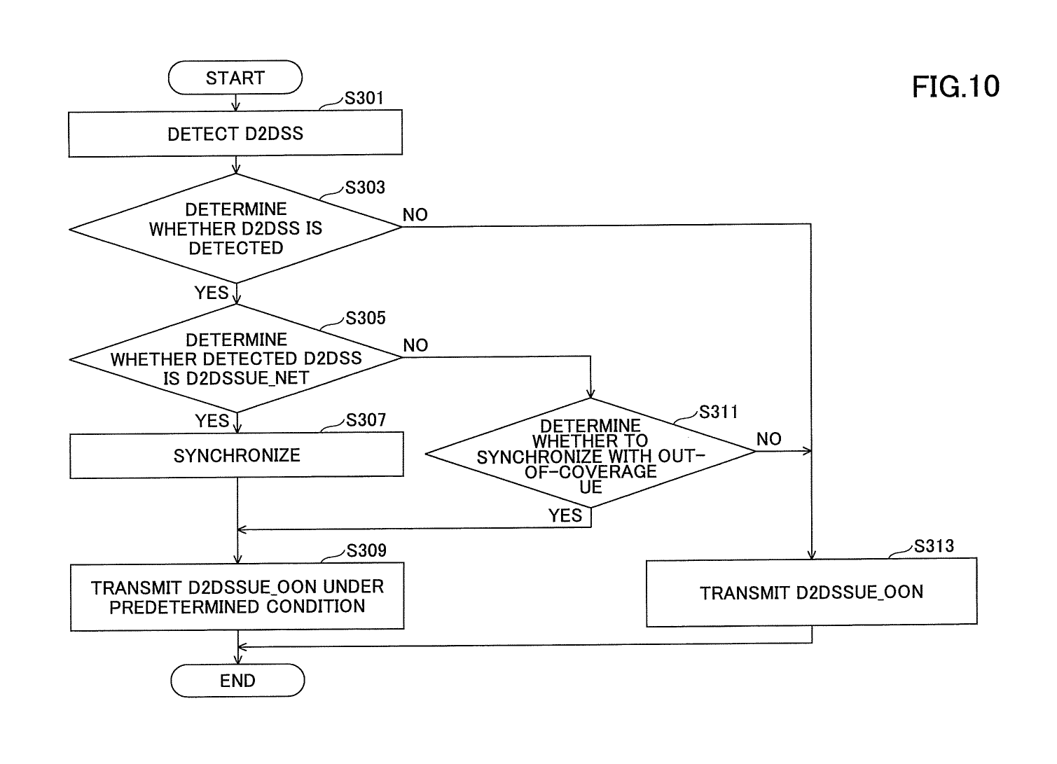

FIG. 10 shows a flowchart illustrating operations of an out-of-coverage user equipment apparatus.

The out-of-coverage user equipment apparatus tries to detect a D2DSS (S301). When a D2DSS is detected (S303:YES) and the sequence of the detected D2DSS is D2DSSue_net (S305:YES), the out-of-coverage user equipment apparatus synchronizes with an in-coverage user equipment apparatus according to D2DSSue_net (S307). Then, the out-of-coverage user equipment apparatus continues detection of a D2DSS, measures the received signal strength of the D2DSS, and transmits D2DSSue_oon when the received signal strength of the D2DSS is less than a predetermined threshold (S309). On the other hand, when the sequence of the detected D2DSS is D2DSSue_oon (S305:NO), the out-of-coverage user equipment apparatus determines whether to synchronize with an out-of-coverage user equipment apparatus which transmits D2DSSue_oon (S311).

When synchronization with the other out-of-coverage user equipment apparatus which transmits D2DSSue_oon is not needed (S311:NO), the out-of-coverage user equipment apparatus continues detection of a D2DSS, measures the received signal strength of the D2DSS, and transmits D2DSSue_oon when the received signal strength of the D2DSS is less than the predetermined threshold (S309). On the other hand, when the out-of-coverage user equipment apparatus synchronizes with the other out-of-coverage user equipment apparatus which transmits D2DSSue_oon (S311:YES), the out-of-coverage user equipment apparatus performs synchronization according to D2DSSue_oon. Then, the out-of-coverage user equipment apparatus continues detection of a D2DSS, measures the received signal strength of the D2DSS, and transmits D2DSSue_oon when the received signal strength of the D2DSS is less than the predetermined threshold (S313).

When a D2DSS is not detected (S303:NO), which corresponds to the case where the received signal strength of the D2DSS is less than the predetermined threshold, the out-of-coverage user equipment apparatus transmits D2DSSue_oon (S313).

<Effects of Embodiments of the Present Invention>

According to an embodiment of the present invention, it is possible to efficiently transmit a D2DSS from an in-coverage user equipment apparatus and to reduce interference caused by a D2D signal from an out-of-coverage user equipment apparatus.

Since the in-coverage user equipment apparatus intermittently transmits D2DSSue_net according to a parameter related to transmission of the D2DSS, rather than continuously transmit D2DSSue_net with constant periodicity (D2DSS period), energy consumption can be reduced. Similarly, since the in-coverage user equipment apparatus intermittently detects D2DSSue_oon transmitted from the out-of-coverage user equipment apparatus according to a parameter related to detection of the D2DSS, rather than continuously detect D2DSSue_oon, interference caused by D2D communication can be detected while energy consumption can be reduced.

When the base station provides signaling as to the parameter setting and configurations of detection and transmission operations, the base station can determine the configurations considering a density of user equipment apparatuses or the like. For example, when a large number of user equipment apparatuses are situated, the base station can shorten the detection duration. In addition, the base station can change the parameter setting and the configuration of detection and transmission operations depending on whether it is during the daytime or during the nighttime, for example.

When the user equipment apparatus autonomously starts or stops detection of D2DSSue_oon and transmission of D2DSSue_net, the user equipment apparatus can flexibly start or stop detection and transmission considering a movement speed, a power level, or the like.

Autonomous start of detection and transmission can be applied to a user equipment apparatus in an idle state (RRC_IDLE). On the other hand, start of detection and transmission according to an instruction from the base station can be applied to a user equipment apparatus in a connected state (RRC_Connected) with the base station. Autonomous stop of detection and transmission can be applied to a user equipment apparatus in which energy consumption needs to be reduced. On the other hand, stop of detection and transmission according to an instruction from the base station can be applied to a user equipment apparatus in which energy consumption is less needed to be reduced.

In addition, since the user equipment apparatus measures interference and transmits the interference measurement result to the base station, the base station can determine the parameter setting and configurations of detection and transmission operations considering the interference measurement result. For example, the base station can lengthen Td_max for a user equipment apparatus with high interference and shorten Td_max for a user equipment apparatus with low interference.

Furthermore, by providing the detection duration and the D2DSS transmission duration within Td_max, the user equipment apparatus can determine a detection duration and a D2DSS transmission duration to be actually used according to a user equipment capability (for example, a power level).

For convenience of explanation, the user equipment apparatus according to the embodiments of the present invention has been described with reference to functional block diagrams, but the user equipment apparatus may be implemented in hardware, software, or combinations thereof. In addition, two or more functional elements may be combined as appropriate. The method according to the embodiments of the present invention may be carried out in a different order from the order shown in the embodiments.

While the approaches are described above to efficiently transmit a D2DSS from an in-coverage user equipment apparatus, the present invention is not limited to the these embodiments, and variations, modifications, alterations, and substitutions can be made by those skilled in the art without deviating from the spirit of the present invention.

The present international application is based on and claims the benefit of priority of Japanese Patent Application No. 2014-227554 filed on Nov. 7, 2014, the entire contents of which are hereby incorporated by reference.

### DESCRIPTION OF NOTATIONS

10 user equipment apparatus
101 application unit
103 baseband signal processing unit
105 transmission/reception unit
107 amplification unit
1030 control unit
1031 signal generation unit
1032 D2DSS generation unit
1033 mapping unit
1034 demodulation unit
1035 symbol determination unit
1036 D2DSS detection unit
1037 interference measurement unit
1038 demodulation unit
1039 symbol determination unit

1. A user equipment apparatus for supporting D2D (user equipment-to-user equipment) communication, the user equipment apparatus being situated in coverage of a base station, comprising:
a control unit configured to determine a transmission duration for which a D2D synchronization signal is transmitted according to a parameter related to transmission of the D2D synchronization signal; and
a transmission unit configured to transmit the D2D synchronization signal within the determined transmission duration of the D2D synchronization signal.

2. The user equipment apparatus as claimed in claim 1,
wherein the control unit determines a detection duration for which a D2D synchronization signal transmitted from an out-of-coverage user equipment apparatus is detected according to a parameter related to detection of the D2D synchronization signal from the out-of-coverage user equipment apparatus; and
the user equipment apparatus further comprises a detection unit configured to detect the D2D synchronization signal transmitted from the out-of-coverage user equipment apparatus within the determined detection duration.

3. The user equipment apparatus as claimed in claim 2, wherein the control unit periodically or according to an instruction from the base station starts detection by the detection unit of the D2D synchronization signal from the out-of-coverage user equipment apparatus, and starts transmission by the transmission unit of the D2D synchronization signal.

4. The user equipment apparatus as claimed in claim 2, wherein when the D2D synchronization signal from the out-of-coverage user equipment apparatus is not detected by the detection unit, or according to an instruction from the base station, the control unit stops detection by the detection unit of the D2D synchronization signal from the out-of-coverage user equipment apparatus, and stops transmission by the transmission unit of the D2D synchronization signal.

5. The user equipment apparatus as claimed in claim 2, further comprising:
an interference measurement unit configured to measure interference caused by the D2D synchronization signal transmitted from the out-of-coverage user equipment apparatus,
wherein the transmission unit transmits an interference measurement result by the interference measurement unit to the base station.

6. The user equipment apparatus as claimed in claim 1, further comprising:
a reception unit configured to receive the parameter related to transmission of the D2D synchronization signal or a parameter related to detection of the D2D synchronization signal from the out-of-coverage user equipment apparatus.

7. The user equipment apparatus as claimed in claim 2, wherein the parameter related to transmission of the D2D synchronization signal includes information used to set the transmission duration for which the D2D synchronization signal is transmitted within a maximum detection duration of the D2D synchronization signal, and the parameter related to detection of the D2D synchronization signal includes information used to set the detection duration for which the D2D synchronization signal is detected within the maximum detection duration of the D2D synchronization signal.

8. A D2D (user equipment-to-user equipment) synchronization signal transmission method in a user equipment apparatus for supporting D2D communication, the user equipment apparatus being situated in coverage of a base station, comprising the steps of:
determining a transmission duration for which a D2D synchronization signal is transmitted according to a parameter related to transmission of the D2D synchronization signal; and
transmitting the D2D synchronization signal within the determined transmission duration of the D2D synchronization signal.

9. The user equipment apparatus as claimed in claim 3, wherein when the D2D synchronization signal from the out-of-coverage user equipment apparatus is not detected by the detection unit, or according to an instruction from the base station, the control unit stops detection by the detection unit of the D2D synchronization signal from the out-of-coverage user equipment apparatus, and stops transmission by the transmission unit of the D2D synchronization signal.

10. The user equipment apparatus as claimed in claim 3, further comprising:
an interference measurement unit configured to measure interference caused by the D2D synchronization signal transmitted from the out-of-coverage user equipment apparatus,
wherein the transmission unit transmits an interference measurement result by the interference measurement unit to the base station.

11. The user equipment apparatus as claimed in claim 4, further comprising:
an interference measurement unit configured to measure interference caused by the D2D synchronization signal transmitted from the out-of-coverage user equipment apparatus,
wherein the transmission unit transmits an interference measurement result by the interference measurement unit to the base station.

12. The user equipment apparatus as claimed in claim 2, further comprising:
a reception unit configured to receive the parameter related to transmission of the D2D synchronization signal or a parameter related to detection of the D2D synchronization signal from the out-of-coverage user equipment apparatus.

13. The user equipment apparatus as claimed in claim 3, further comprising:
a reception unit configured to receive the parameter related to transmission of the D2D synchronization signal or a parameter related to detection of the D2D synchronization signal from the out-of-coverage user equipment apparatus.

14. The user equipment apparatus as claimed in claim 4, further comprising:
a reception unit configured to receive the parameter related to transmission of the D2D synchronization signal or a parameter related to detection of the D2D synchronization signal from the out-of-coverage user equipment apparatus.

15. The user equipment apparatus as claimed in claim 5, further comprising:
a reception unit configured to receive the parameter related to transmission of the D2D synchronization signal or a parameter related to detection of the D2D synchronization signal from the out-of-coverage user equipment apparatus.

16. The user equipment apparatus as claimed in claim 3, wherein the parameter related to transmission of the D2D synchronization signal includes information used to set the transmission duration for which the D2D synchronization signal is transmitted within a maximum detection duration of the D2D synchronization signal, and the parameter related to detection of the D2D synchronization signal includes information used to set the detection duration for which the D2D synchronization signal is detected within the maximum detection duration of the D2D synchronization signal.

17. The user equipment apparatus as claimed in claim 4, wherein the parameter related to transmission of the D2D synchronization signal includes information used to set the transmission duration for which the D2D synchronization signal is transmitted within a maximum detection duration of the D2D synchronization signal, and the parameter related to detection of the D2D synchronization signal includes information used to set the detection duration for which the D2D synchronization signal is detected within the maximum detection duration of the D2D synchronization signal.

18. The user equipment apparatus as claimed in claim 5, wherein the parameter related to transmission of the D2D synchronization signal includes information used to set the transmission duration for which the D2D synchronization signal is transmitted within a maximum detection duration of the D2D synchronization signal, and the parameter related to detection of the D2D synchronization signal includes information used to set the detection duration for which the D2D synchronization signal is detected within the maximum detection duration of the D2D synchronization signal.

19. The user equipment apparatus as claimed in claim 6, wherein the parameter related to transmission of the D2D synchronization signal includes information used to set the transmission duration for which the D2D synchronization signal is transmitted within a maximum detection duration of the D2D synchronization signal, and the parameter related to detection of the D2D synchronization signal includes information used to set the detection duration for which the D2D synchronization signal is detected within the maximum detection duration of the D2D synchronization signal.
